(19) United States
(12) Patent Application Publication
(10) Pub. No.: US 2024/0428208 A1
(43) Pub. Date: Dec. 26, 2024

(54) SYSTEMS AND METHODS FOR NETWORK MESSAGING INTEROPERABILITY BETWEEN DIFFERENT REGIONS

(71) Applicant: VOCALINK INTERNATIONAL LIMITED, LONDON (GB)

(72) Inventors: Boy Anthony Kuhne, London (GB); Navin Chintaka Abhaya Samarakoon, Pinner (GB); Richard Peter Barnes, Chesham (GB); Richard Michael Jones, Chesham (GB)

(21) Appl. No.: 18/749,480

(22) Filed: Jun. 20, 2024

Related U.S. Application Data
(60) Provisional application No. 63/522,980, filed on Jun. 23, 2023.

(51) Int. Cl. G06Q 20/02; G06Q 20/38

(52) U.S. Cl. CPC G06Q 20/027; G06Q 20/381

(57) ABSTRACT

Systems and methods are provided for cross-border network messaging. An example computer-implemented method includes receiving, from an institution, a transfer request for a real-time transfer, via a real-time payment (RPT) provider, from a sender in a first region to a recipient in a second region. The transfer request includes an amount to be transferred and a proxy unique to the recipient. The method also includes resolving the proxy into account data for an account of the recipient and requesting a quote associated with conversion of the amount from a currency of the first region to a currency of the second region. The method further includes directing the RTP provider to transfer funds, as defined by the quote, from the institution to a liquidity receiver in the first region, submitting the transfer request to a gateway in the second region, and receiving a confirmation of the transfer in the second region.

### CROSS-REFERENCE TO RELATED APPLICATION

This application claims the benefit of, and priority to, U.S. Provisional Application No. 63/522,980, filed Jun. 23, 2023. The entire disclosure of the above application is incorporated herein by reference.

### FIELD

The present disclosure generally relates to systems and methods for use in facilitating network messaging to provide interoperability between multiple different regions.

### BACKGROUND

This section provides background information related to the present disclosure which is not necessarily prior art.

Institutions are known to facilitate network messaging for various different purposes. Transferring funds is one such purpose, in which messaging is used to instruct the transfer of the funds from one account to another account. When the transfer of funds extends between different countries, the transfer may be referred to, for example, as a cross-border (or international or non-domestic) transfer. In connection therewith, the transfer may further involve different currencies, whereby an exchange of one currency for another is also included in the transfer. It is common for institutions involved in such cross-border transfers to partner or cooperate with institutions in other countries to facilitate the transfers in those regions.

### DRAWINGS

The drawings described herein are for illustrative purposes only of selected embodiments and not all possible implementations, and are not intended to limit the scope of the present disclosure.

FIG. 1 is an example system of the present disclosure suitable for use in providing network messaging between different regions;

FIG. 2 is a block diagram of an example computing device that may be used in the system of FIG. 1;

FIG. 3 is an example method that may be implemented in the system of FIG. 1, or otherwise, for facilitating network messaging between different regions;

FIG. 4 is an example method that may be implemented in the system of FIG. 1, or otherwise, for settling fund transfers between different regions; and

FIG. 5 is an example method that may be implemented in the system of FIG. 1, or otherwise, for facilitating network messaging between different regions.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Cross-border transfers often require institutions (e.g., banks, etc.) involved in the transfers (or transactions) (e.g., sender institutions, etc.) to maintain or hold funds in each of the regions to which funds may be transferred (in respective currencies of the regions), or to rely on partner institutions in those countries to act on their behalf. What's more, cross-border transfers generally include delays (e.g., of several days, etc.), for example, due to the requirement for added network communications between different institutions in the different countries, multiple processes required to perform the transfers/transactions, limited operating hours, differing time zones, etc. The delays may be inefficient, time consuming and costly (e.g., cross-border transfers may cost five times or ten times as much as a domestic real-time transfer, etc.).

Uniquely, in connection with fund transfers, the systems and methods herein provide for coordination of messaging between the different regions, through rules-based logic included in a network of gateways, to provide enhanced performance in the transfers (e.g., to provide real-time performance, etc.) and thus interoperability between the different regions. In this manner, the network of gateways provides for interoperability between existing real-time payment (RTP) networks, which, in turn, enables, the RTP networks to interlink and initiate and receive international real-time payments.

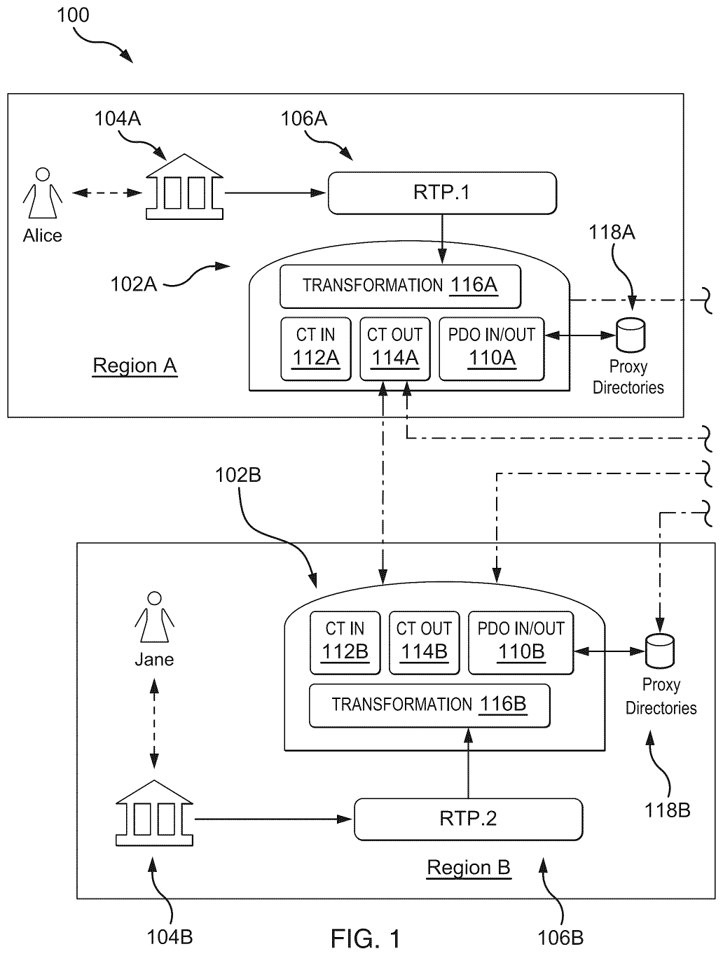

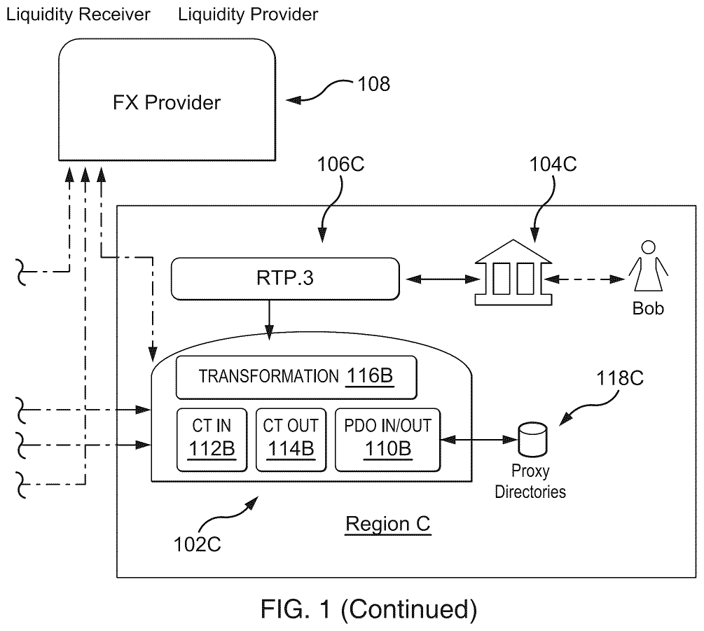

FIG. 1 illustrates an example system 100, in which one or more aspects of the present disclosure may be implemented. Although the system 100 is presented in one arrangement in FIG. 1, other embodiments may include systems arranged otherwise depending, for example, on a manner of messaging, standards employed in the networks, region-based rules and regulations, privacy rules and regulations, etc.

In the illustrated embodiment, the system 100 generally defines a multi-region real-time payment scheme, which in this example expands across three distinct regions. As shown, the regions include Region A, Region B, and Region C. Each of the regions, in turn, includes a real-time payment gateway, or gateway 102, which is gateway 102A in Region A, gateway 102B in Region B, and gateway 102C in Region C. That said, it should be appreciated that the present disclosure is not limited to three regions, as it may include two regions or more than three regions.

The regions may be different states, territories, countries, or other suitable divisions (e.g., based on physical boundaries, geo-political boundaries, etc.), etc. In general, the Regions A-C are each defined by laws, agreements, borders, or otherwise, etc., and are associated with a standard currency (one or more of which is potentially different from the other). In this example embodiment, a first standard currency is used in Region A, and second and third different standard currencies are used in each of Region B and Region C, respectively. For example, Region A may include the United States with a currency of United States dollars (USD), while Region B may include Thailand with a currency of Thai baht (THB) and Region C may include Japan with a currency of yen. Consequently, then, a transfer between a user in Region A (e.g., Alice, etc.) with a user in Region B (e.g., Jane, etc.) is not only a cross-border transfer, but also a cross-currency transfer.

In this example embodiment, the system 100 includes an institution 104 in each of the regions. The institutions 104 each include a bank or other financial institution, in this example embodiment, which is configured to hold funds in accounts. In particular, in this example, the institutions 104 are configured to issue accounts to users in the region in which the institution is located. For example, the institution 104A in Region A is configured to issue an account to Alice, who is a user in Region A, while the institution 104B in Region B is configured to issue an account to Jane, who is a user in Region B. The same applies to the institution 104C in Region C.

It should be appreciated that in various embodiments, each of the regions generally includes multiple different institutions, each consistent with the description above.

Additionally, as shown, each region includes at least one real time payment provider 106. The RTP provider 106 is configured to facilitate real time transfers between different accounts associated with the RTP provider 106 and issued, generally, by the institutions 104. More specifically, the RTP provider 106 is configured to receive a request for real time transfers, from a sender user (or payer) (e.g., via the institution 104 associated with the sender user, etc.), to a recipient user (or payee) (e.g., via the institution 104 associated with the sender user, etc.), and to facilitate messaging to execute the real time transfers between the respective accounts, either directly with the institution(s) or through one or more intermediaries. Example RTP providers 106 may include The Clearing House (TCH) in the United States, and the Interbank Transaction Management and Exchange (ITMX) in Thailand. Various other examples of such providers are available in various regions. As shown in FIG. 1, Region A includes RTP provider 106A, Region B includes RTP provider 106B, and Region C includes RTP provider 106C. That said, while only one RTP provider is illustrated in each region in FIG. 1, it should be appreciated that in other example embodiments one or more of the regions may include more than one RTP provider. In such embodiments, each RTP provider in the same region may have its own gateway (for example, whereby a message transformation service of the gateway (see below) is specific to that RTP provider, etc.).

It should be appreciated that any number of RTP providers 106 may be included in any number of regions in other systems embodiment.

In this example embodiment, the system 100 includes an exchange and/or liquidity host 108, which is located in one or more of the Regions A-C. The exchange/liquidity host 108 is configured to provide for currency conversion in some instances and also to provide liquidity in each of the regions in other instances. As such, the exchange/liquidity host 108 may include a bank or other financial institution, or financial service, etc. It should be understood that the exchange/liquidity host 108 may be divided into an exchange provider or FX provider in some instances, and a liquidity host in other instances, or a combination thereof, which may then be separate institutions, each configured consistent with the respective roles. In connection therewith, the liquidity host (of host 108) may be a liquidity receiver and/or a liquidity provider, depending on a direction of transfer with respect to a given region. It should be still further understood that multiple of each FX provider and liquidity provider/receiver (e.g., as the exchange/liquidity host 108, etc.) may be located in each region, whereby each may contend against one another to provide the described services for RTP transfers to the gateways 102. That said, depending on the direction of transfer, the same host 108 may be a liquidity receiver or a liquidity provider in the region. In addition, in some embodiments, the same host 108 may extend across multiple regions.

In this example embodiment, each gateway 102 includes a payment data orchestration (PDO) service 110 (e.g., having a PDO in service and a PDO out service, etc.), a credit transfer (CT) in service 112, a CT out service 114, and a message transformation service 116. As noted, in various example embodiments, the PDO service 110 may include a PDO in service and a PDO out service. And, while the PDO in service and PDO out service are illustrated as a single component in the figures (PDO in/out service 110), they may be separate components in other embodiments (e.g., similar to the CT in service 112 and the CT out service 114, etc.).

In particular, the PDO in/out service 110 configures the gateway 102 to provide for proxy resolution (e.g., both domestic and internal, as to the region in which the gateway is located, etc.), requests for currency exchange, reachability checking, account verification, and sanction checking, as applicable or required. The CT in service 112 configures the gateway 102 to receive incoming RTP requests from other gateways, to facilitate information exchange for sanction checking by entities involved in the credit transfer, and to execute the transfer with one or more RTP providers 106 in the same region. The CT out service 114 configures the gateway 102 to send RTP requests, originated in the region of the gateway 102, to other regions. And, the message transformation 116 configures the gateway 102 to transform messaging to/from the respective RTP provider 106 between the specific standard of the RTP provider 106 and an inter-regional standard (e.g., defining internal canonical messaging, etc.) by and between the gateways 102 in the different regions, as necessary.

Based on the above, as an example, Alice requests, from the institution 104A in Region A, a transfer of funds from an account issued to Alice, by the institution 104A, via the RTP provider 106A, to an account issued to Jane by the institution 104B in Region B. The request includes an amount in a local currency and a proxy for Jane's account, which is issued by the institution 104B in Region B. The proxy may include, without limitation, a phone number (e.g., a mobile phone number, etc.), email address, bank number, identifier, etc. In this example, the request includes Jane's mobile phone number.

In response to the request, the institution 104A is configured to submit the request to the RTP provider 106A. The RTP provider 106A is configured to submit the request to the gateway 102A in Region A. It should be appreciated that in at least one embodiment, the institution 104A may be configured to submit the transfer request directly to the gateway 102A.

Upon receipt of the transfer request, the gateway 102A is configured, by the message transformation service 116A, to transform the request from the RTP provider 106A to the inter-regional standard. The gateway 102A is configured, by the PDO in/out service 110A, to acquire an FX rate, resolve the proxy, establish the reachability of the destination institution 104B via the payment scheme (e.g., and a standing of the account to receive the transfer, etc.), and check any sanction associated with the account(s) involved in the transfer (e.g., Alice's account, etc.). In particular, the gateway 102A is configured, by the PDO in/out service 110A, to search for the proxy in a local proxy directory 118A, as shown in FIG. 1 and/or to determine, based on one or more rules, a region associated with the proxy (e.g., based on country code, etc.). In this example, the phone number included in the request is local to Region B, whereby the gateway 102A is configured, by the PDO in/out service 110A, to identify Region B for resolving the proxy. Next, the gateway 102A is configured, by the PDO in/out service 110A, to submit a proxy resolution request to Region B, and in particular, to the gateway 102B in Region B.

The gateway 102B is configured, by the PDO in/out service 110B, to search in the local proxy directory 118B for either the account details and/or an identification of the institution 104B. The gateway 102B may then be configured, by the PDO in/out service 110B, to check participant and scheme rule validation(s) and to request proxy resolution from the institution 104B. The institution 104B is configured to return account data (e.g., account number, etc.) (e.g., which is encrypted, etc.) to the gateway 102B. The gateway 102B is configured, by the PDO in/out service 110B, to respond to the gateway 102A with the account data. In addition, the gateway 102B is configured, by the PDO in/out service 110B, to check one or more sanction lists for the account data and/or the proxy (e.g., a sanction notification from one or more entities associated with the sanction lists, etc.). The sanction lists may be maintained by the institution 104B or any party associated with authorizing, clearing, settling, or regulating transfers in Region B. It should be appreciated that sanction checking may be performed in Region A and/or Region B for the example transfer. In turn, the gateway 102B is configured, by the PDO in/out service 110B, to respond to the gateway 102A with results of the sanction checking.

In connection with the sanction checking discussed above, it should be appreciated that multiple entities may keep and publish a list of individuals, organizations, and/or countries that are under some form of financial sanction. Such lists may include, for example, and without limitation, the Specially Designated Nationals List (SDNL) published by the Office of Foreign Assets Control (OFAC) (U.S. Department of the Treasury), which includes individuals and companies owned or controlled by, or acting for or on behalf of, targeted countries and that are subject to certain sanctions; the UK Sanctions List published by the Office of Financial Sanctions Implementation (OFSI) (UK HM Treasury), which includes all those subject to sanctions measures in the UK; the Consolidated United Nations Security Council Sanctions List, which includes the names of individuals and entities subject to measures imposed by the Security Council (relating to terrorism, nuclear proliferation, and human rights violations, etc.); the European Union (EU) sanctions list, which includes individuals, entities, and bodies covered by EU financial sanctions; the Australian Sanctions List published by the Australian Department of Foreign Affairs and Trade, which includes all persons and entities to whom targeted financial sanctions or travel bans apply under Australian sanction laws; and the Canadian Sanctions List published by the Office of the Superintendent of Financial Institutions (OSFI), which includes individuals and entities subject to sanctions under laws relating to Terrorism Financing, United Nations Resolutions, and other Economic Measures. Financial institutions and other businesses conducting international transactions typically screen their customers against these lists to ensure compliance with various international sanctions and anti-money laundering (AML) laws.

Further, based on the transfer request, the gateway 102A is configured, by the PDO in/out service 110A, to request an exchange or FX rate from the host 108. The host 108 is configured to determine the rate for the conversion from the currency in Region A to the currency in Region B and to return the rate (e.g., as a FX quote, etc.) to the gateway 102A. It should be appreciated that the request for the exchange or FX rate may occur either before or after proxy resolution, or even at about the same time.

When the proxy is resolved, the receiving institution 104B and its identified account for Jane are verified for reachability, and the sanction checking is completed, the gateway 102A is configured, by the PDO in/out service 110A, to respond to the transfer request with a quote for the transfer. For example, the quote may includes fees, etc., associated with the transfer (e.g., “The transfer of $10USD will cost $11.20USD, where Jane will receive 346 Thai Baht,” etc.). The response is provided to the institution 104A, directly or via the RTP provider 106A. The institution 104A in turn is configured to present the response, in whole or in part, to Alice, who may then accept the transfer or not.

Upon acceptance, the institution 104A is configured to send funds, consistent with the quote (e.g., transfer amount and fee(s), etc.), in the currency on Region A, to the RTP provider 106A. The RTP provider 106A is configured to check a balance of institution 104A, reserve the funds for the transfer, and then to send payment to the host 108 and direct the gateway 102A to perform the transfer.

In turn, the gateway 102A is configured, by the CT out service 114A, to confirm the transfer with the host 108, whereupon the host 108 is configured to confirm the credit from the RTP provider 106A, and to provide confirmation of an exchange contract consistent with the quote to the gateway 102A. The gateway 102A is configured, by the CT out service 114A, to submit the transfer to the gateway 102B in Region B. The gateway 102A is further configured, by the CT out service 114A, to notify the RTP provider 106A of the complete settlement of the transfer between the institution 104A and the host 108.

The institution 104A is configured to inform Alice of the transfer.

In Region B, then, the gateway 102B is configured, by the CT in service 112B, to indicate the transfer from the host 108 to the RTP provider 106B. In turn, the host 108 is configured (given the receipt of the transfer in Region A) to authorize the transfer. The gateway 102B is configured, by the CT in service 112B, to send payment to the RTP provider 106B, on behalf of the host 108. The RTP provider 106B is configured to confirm that the host 108 possesses the funds, to reserve the funds, and then to transfer funds to the institution 104B. The Institution 104B is configured to accept the transfer from the RTP provider 106B. The RTP provider 106B is configured to then transfer the funds between the host 108 and the institution 104B (i.e., into jane's account). The institution 104B is also configured to notify Jane of the transfer into Jane's account with the institution 104B according to local rules.

In the above example embodiment, the gateway 102A and the gateway 102B are configured for an “asynchronous” processing of the credit transfer, where there is a transfer in Region A and then a different, separate transfer in Region B. That is, the transfer is processed in two, separate steps: first, the transfer is completed and settled in Region A, before the gateway 102A forwards the transfer to the gateway 102B in Region B, and then, second, the transfer is completed and settled in Region B. The asynchronous processing further supports where the transfer is rejected in Region B, even after the transfer is settled in Region A.

In connection with the institution 104B rejecting the transfer in Region B, for example, the gateway 102B is configured, by the CT in service 112B, to receive a rejection message from the RTP provider 106B and to provide the message to the host 108 in region B, directly, and in Region A, through the gateway 102A.

In turn, the gateway 102A is configured, by the CT out service 114A, to either (or both) (e.g., depending on cross-border rules for exceptions, etc.) send a notification message (e.g., an email, an ISO 20022 message, an admi.004 message, etc.) to facilitate a transfer reversal on behalf of the host 108 in Region A to the RTP provider 106A, or to generate a transfer/payment reversal on behalf of the host 108 in conjunction with the RTP provider 106A and/or the institution 104A. The RTP provider 106A is configured to check a balance of host 108, to reserve funds associated with the account, and to issue a transfer instruction to the institution 104A to reverse the prior transfer. The institution 104A is configured to confirm the transfer, whereby the RTP provider 106A is configured to debit the amount from the host 108 and credit the amount of the transfer to the institution 104A. The RTP provider 106A is then configured to confirm the transfer to the institution 104A, whereby the funds are repaid to Alice, and to the gateway 102A. The gateway 102A is then configured to notify the host 108 of completion of the reversal based on the rejection.

Alternatively, in other embodiments relative to the above, the gateways 102 may be configured for “synchronous” processing of the transfer, where the transfer is processed in one step: the gateway 102A forwards the payment to the gateway 102B for settlement in Region B, which is completed and confirmed prior to settlement in Region A. In such an example embodiment (consistent with the above example), after funds are received at the RPT provider 106A, the RTP provider 106A is configured to authorize the gateway 102A to perform the transfer.

In turn, the gateway 102A is configured, by the CT out service 114A, to convert the currency accordingly and to submit the transfer to the gateway 102B in Region B. The gateway 120A is further configured, by the CT out service 114A, to notify the RTP provider 106A of the complete settlement of the transfer between the institution 104A and the host 108.

The gateway 102B is configured, by the CT in service 112B, to convert the transaction back to the currency of Region B, if not done so already, and to indicate the transfer from the host 108 to the RTP provider 106B. In turn, the RTP provider 106B is configured to confirm that the host 108 possesses the funds, to reserve the funds, and then to transfer funds to the institution 104B. The institution 104B is configured to accept the transfer from the RTP provider 106B and to notify Jane of the transfer. The RTP provider 106B is configured to then settle with the host 108 and the institution 104B according to local rules and to notify the gateway 102B of the settlement.

The gateway 102B is configured, by the CT out service 114B, to notify the gateway 102A in Region A that the transfer is settled in Region B. In turn, the gateway 102A is configured, by the CT out service 114A, to convert the transaction back to the currency of Region A and to notify the RPT provider 106A. The RTP provider 106A is configured to settle the transfer between the host 108 and the institution 104A.

While the above examples are described with reference to Region A and Region B, and the parts thereof, it should be appreciated that the transfer may be between any combination of Regions A, B, C or other regions in which a gateway is located. This is provided through multi-lateral connectivity of the gateways 102 in the various different Regions A, B, C. The communication by and between the gateways 102 is consistent with a REST API message, whereby each gateway 102 is configured to receive messages from each other gateway 102. That said, other forms and formats of messaging by and between the gateways 102 may be included in other system embodiments.

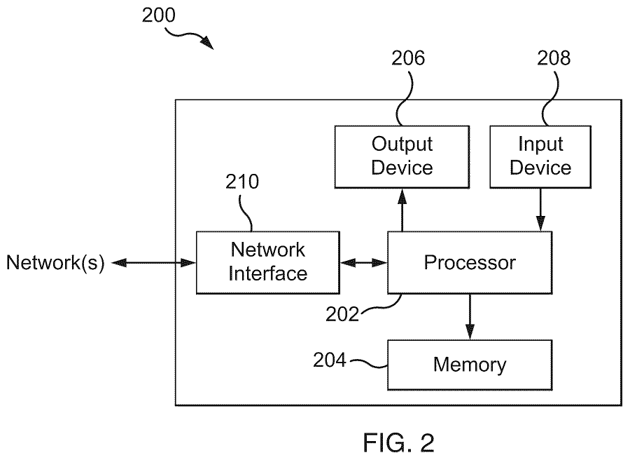

FIG. 2 illustrates an example computing device 200 that can be used in the system 100. The computing device 200 may include, for example, one or more servers, workstations, personal computers, POS terminals, laptops, tablets, smartphones, PDAs, virtual devices, etc. In addition, the computing device 200 may include a single computing device, or it may include multiple computing devices located in close proximity or distributed over a geographic region as a network of computing devices, so long as the computing devices are specifically configured to function as described herein. In particular, in the example system 100 of FIG. 1, each of the gateways 102, the institutions 104, the RTP providers 106, the host 108, etc., and also the PDO in/out service 110, the CT in service 112, the CT out service 114, and the message transformation service 116, etc., should be understood as being implemented in (and/or otherwise including) one or more computing devices generally consistent with or at least partially consistent with the computing device 200. That said, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, proxies, rules, liquidity balances, and/or other types of data (and/or data structures) suitable for use as described herein. Furthermore, in various embodiments, executable instructions may be stored in the memory 204 for execution by the processor 202 to cause the processor 202 to perform one or more of the operations described herein (e.g., one or more of the operations described in method 300, etc.), such that the memory 204 is a physical, tangible, and non-transitory computer readable storage media. Such instructions often improve the efficiencies and/or performance of the processor 202 that is performing one or more of the various operations herein, whereby the instructions (when performed by the processor 202) effectively transform the computing device 200 into a special purpose device configured to perform the unique and specific operations described herein. It should be appreciated that the memory 204 may include a variety of different memories, each implemented in one or more of the functions or processes described herein.

In addition in the example embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., a solicitation to confirm a rate quote for the transfer, etc.), either visually or audibly, to a user of the computing device 200, etc. And, various interfaces (e.g., as defined by applications, webpages, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

The computing device 200 also includes an input device 208 that receives inputs from the user of the device (i.e., user inputs) such as, for example, amounts and/or proxies associated with transfer requests, etc. The input device 208 is coupled to (and is in communication with) the processor 202 and may include, for example, a keyboard, a pointing device, a mouse, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, including one or more of the networks in FIG. 1. Further, in some example embodiments, the computing device 200 may include the processor 202 and one or more network interfaces (including the network interface 210) incorporated into or with the processor 202.

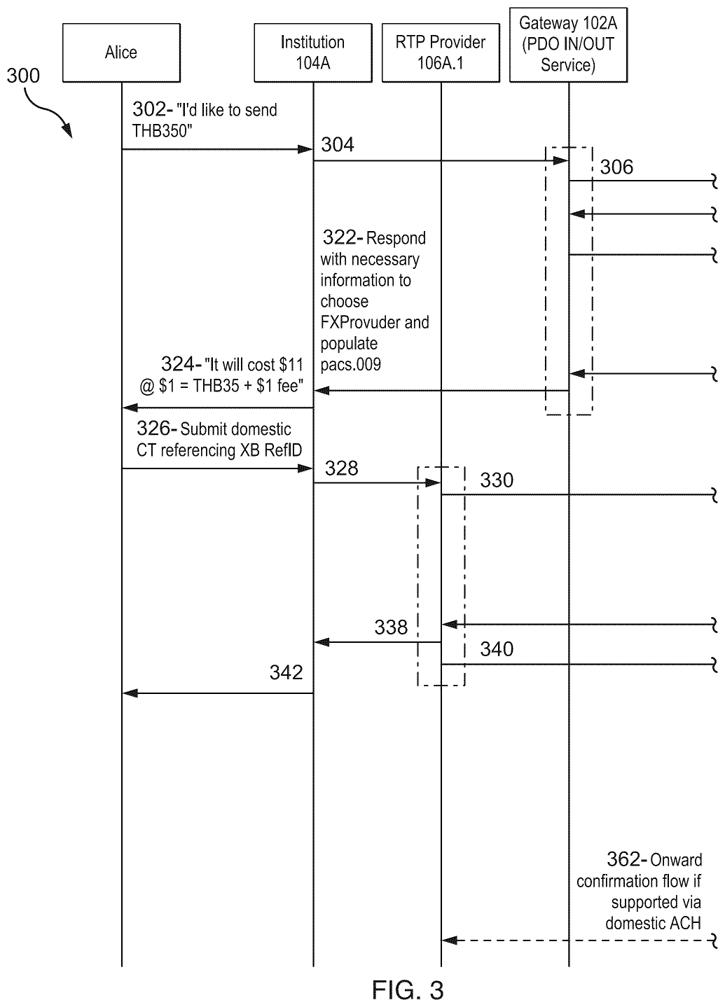

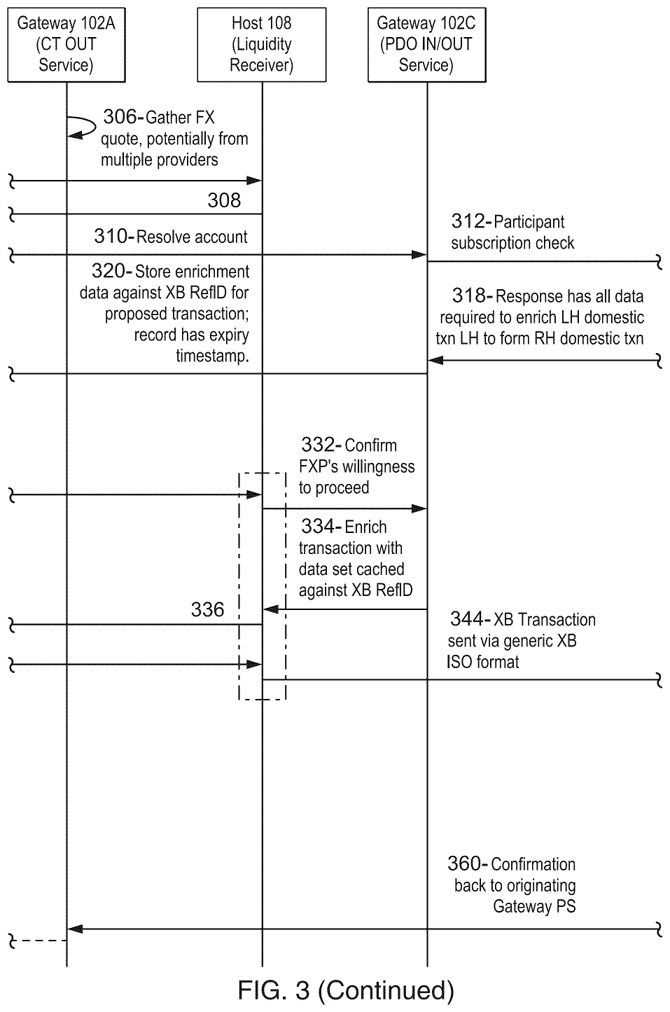

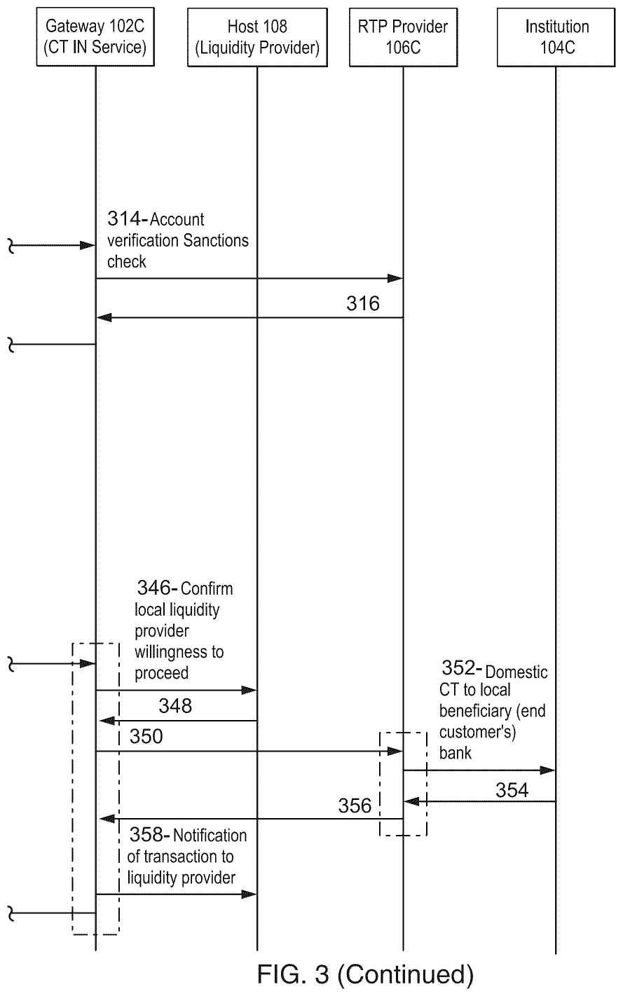

FIG. 3 illustrates an example method 300 for use in facilitating a cross-border, or cross-currency, transaction. While the method 300 is generally consistent with the above description of the operation of the system 100, as including the computing device 200, it should be appreciated that the methods herein are not limited to the system 100, or computing device 200. And, likewise, the systems and computing devices described herein are not limited to the example method 300.

At the outset, in this specific example embodiment, Alice wants to send a real time payment to Bob, based on Bob's phone number, which is represented by +66-XXXXX-XXXX (i.e., having country code for Thailand, which may be Region C). Alice is located in the United States, which may be Region A, and the institution 104A is also located in the United States. In connection therewith, in one example, Alice may access a mobile application on a mobile device (e.g., mobile phone, tablet, etc.), and also indicate a desire to transfer funds. In response, the mobile device displays a screen to Alice, which solicits an amount of a transfer and a proxy of the recipient, Bob (e.g., the phone number for Bob, an email address, or other unique identifier, etc.). Alice then enters the phone number for Bob, represented by +66-XXXXX-XXXX, and the amount of the transfer in the destination currency (e.g., Thai baht, etc.) (or potentially, in another currency, such as, for example, USD, etc.). In another example, Alice may access an application on a desktop computing device, and proceed in the same manner.

In response, in this example, the mobile device (not shown) submits, at 302, a transfer instruction to the institution 104A in Region A, which is the institution that issued an account (i.e., source account) from which the funds are to be transferred. It should be appreciated that the source account may be issued by another institution in one or more other embodiments. Again, it should be appreciated that proxies other than phone numbers may be used in other examples (e.g., email addresses, other unique identifiers for users, etc.). The institution 104A submits, at 304, the transfer request to the gateway 102A in Region A. It should be appreciated that the transfer request may be directed to the RTP provider 106A, which is also located in Region A (as shown in FIG. 1), which, in turn, forwards the transfer request to the gateway 102A, or the transfer request may be submitted directly to the gateway 102A. In addition, the institution 104A may also generate a cross-border transfer identifier for the transfer and include the identifier with the transfer request.

Upon receipt of the transfer request, at 306, the gateway 102A requests an exchange quote from USD to THB, from one or more providers, including the specific host 108. The host 108 responds, at 308, with the exchange quote. The exchange quote may indicate a specific rate for conversion, along with any applicable fees associated with the conversion.

In this example embodiment, the gateway 102A submits the proxy included in the transfer request for resolution and/or for sanction check. In particular, the gateway 102A submits, at 310, the proxy to the gateway 102C, which is located in Region C or Thailand in this example. The gateway 102C resolves the proxy, which in this example, is the phone number for Bob, into account data, which may include, without limitation, an account number indicative of the account of Bob, as issued by the institution 104C. When the proxy is resolved, the account data is passed from the PDO in/out service 110C to the CT in service 114C within the gateway 102C, at 312. Then, at 314, the gateway 102C submits the account data to the RTP provider 106C in the Region C for sanctions checking. The RTP provider 106C checks to determine if the account is in good standing and/or associated with any applicable sanction, which may prevent the transfer to the specific account. Upon verification, the RTP provider 106C responds, at 316, with a verification of the sanction check to the gateway 102C at the CT in service 114C. The verification is passed from the CT in service 114C to the PDO in/out service 110C, at 318. The gateway 102C further compiles sufficient data for execution of the transfer in Region C, which may be understood to included enriching the account data, institution data, etc.

At 320, the gateway 102C records the data along with the cross-border transfer identifier, imposes an expiration timestep on the record (e.g., a time interval within which the transfer should be directed, received or executed, etc.), and provides a confirmation to the gateway 102A. The ability to store data relating to the proposed future credit transfer transaction locally within the gateway 102C in the receiving region of that transaction may facilitate such transaction, which spans jurisdictions. Some of the data gathered by the gateway 102C may, under data regulation legislation within Region C, be considered sensitive or personal data which may not be transmitted out of region. Storing this data locally within the gateway 102C, such that it can be later used to enrich and complete the transaction message submitted at step 350 herein, may allow for completing the transaction across jurisdictions while respecting data privacy and on-soil data legislation in the respective regions.

Upon receipt of the confirmation, the gateway 102A responds, at 322, to the institution 104A (either directly or via the RTP provider 106A) with the information to choose a host (when multiple host provide quotes) and the resulting cost associated with the transfer (along with other information suitable to complete a pacs.008 message as part of the ISO 2022 standard messaging protocol and the cross-border transfer identifier, etc.). The institution 104A then informs Alice at her mobile device, of the quote(s) and the option to proceed. In this example, as shown, only the host 108 has provided a quote, whereby the message indicates “It will cost $11 (USD) @ $1−TBH35+$1 (USD) fee” to make the transfer as requested. Alice may then accept or decline the transfer. Here, Alice accepts, at 326.

In turn, at 328, the institution 104A reserves the funds in Alice's account and submits the transfer to the RTP provider 106A, which includes the cross-border transfer identifier.

At 330, the RTP provider 106A submits the transfer request to the gateway 102A, and specifically, the CT out service 114A. The gateway 102A submits a confirmation or authorization request, at 332, to the host 108 (e.g., the selected host, etc.), to determine if the exchange quote is still valid and/or acceptable to the host 108. At 334, the host 108 responds, in this example, with a confirmation and/or authorization, and may further, as illustrated, add data associated with the transfer based on the cross-border transfer identifier. Thereafter, at 336, the gateway 102A responds to the RTP provider 106A with a message to proceed with the transfer. The message to proceed is forwarded to the institution 104A, at 338, whereby settlement is initiated for the transfer from the institution 104a to the host 108. Alice is notified, by the institution 104A, at 342. The RTP provider 106A also notifies the gateway 102A of the transfer, at 340.

It should be appreciated that each message, request and/or response between the gateway 102A and another part may be transformed by the transformation service 116A, as necessary or desired to ensure proper communication with the gateway 102A.

The transfer is then handed off from the gateway 102A to the gateway 102C in Region C, at 344. In connection therewith the transfer is a common format between the gateways, which contains all the associated data for the transfer, as necessary or desired.

Upon receipt of the transfer, the gateway 102C, and specifically, the CT in service 112C, transforms the message to a format consistent with the host 108 in Region C (which may include enriching the data with the information previously stored, at 320, against the cross border transaction identifier) and sends a request to participate to the host 108, at 346, in the local currency (e.g., THB, etc.). The host 108 confirms a willingness to participate in the transfer, at 348. In turn, the gateway 102C sends, at 350, the transfer to the RTP provider 106C in Region C, which is on behalf of the host 108. The RTP provider 106C checks an account associated with the host 108 in Region C and sends the transfer, at 352, in local currency (e.g., THB, etc.) to the institution 104C. The institution 104C accepts the transfer, at 354. The RPT provider 106C then settles the transfer between the host 108 and the institution 106C. The RTP provider 106C notifies the gateway 102C of the transfer, at 356, and the gateway 102C notifies the host 108 of the transfer, at 358.

The gateway 102C also notifies the gateway 102A of the transfer, at 360. At 362, the confirmation is provided from the gateway 102A to the RTP provider 106A and others in Region A, as necessary or desired.

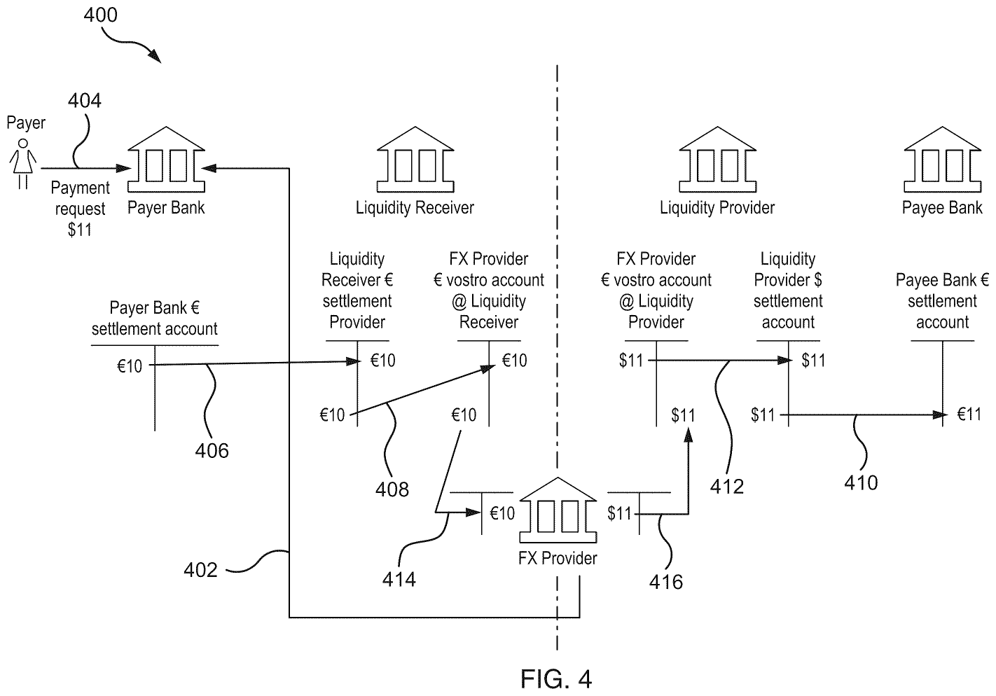

In connection with the above, the settlement of the transfer is included. It should be appreciated that the timing of the settlement may vary from region to region, or party to party depending on the particular implementation. One example settlement method 400 between two different regions, as indicated by the dotted lines, is illustrated in FIG. 4 and described below. That said, it should be appreciated that settlement in connection with the system 100 and/or the method 300 may be otherwise in those embodiments.

With reference to FIG. 4, at 402, the FX provider (e.g., the host 108, etc.) (which is associated with or includes a liquidity receiver) provides a conversion quote for an exchange of one currency to another currency, or Euros € to dollars (USD) in this example.

In connection with a transfer, then, at 404, a payer requests a transfer to a payee in a different region, whereby the payer bank (e.g., the institution 104B in Region B, etc.) provides the conversion quote. Upon acceptance, at 406, the payer bank initiates payment in a sending country system and sends a euro equivalent of $11 (i.e., €10) to the FX Provider. At 408, an internal accounting is performed at the liquidity receiver (e.g., as part of the host 108, etc.). The payment of $11 is then made, at 410, from the liquidity provider to the payee bank (e.g., the institution 104A in Region A). The payee account is then credited for the amount.

At 412, an internal accounting is performed at the liquidity provider. For instance, at a time of settlement, as defined on the one or more regions, for example, the liquidity receiver pays the FX provider, at 414, and the FX provider pays the liquidity provider, at 416. It should be appreciated that, in some example embodiments, settlement of the transfer may occur across, or along with, multiple other transfers (e.g., in bulk, etc.), which would allow for efficiencies in processing multiple transfers together.

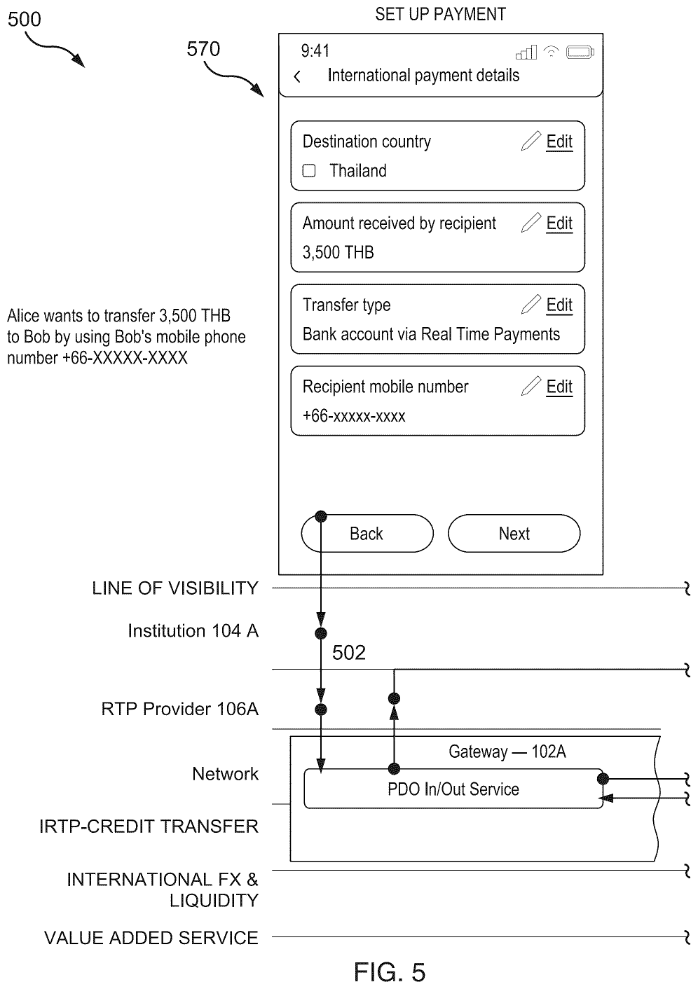

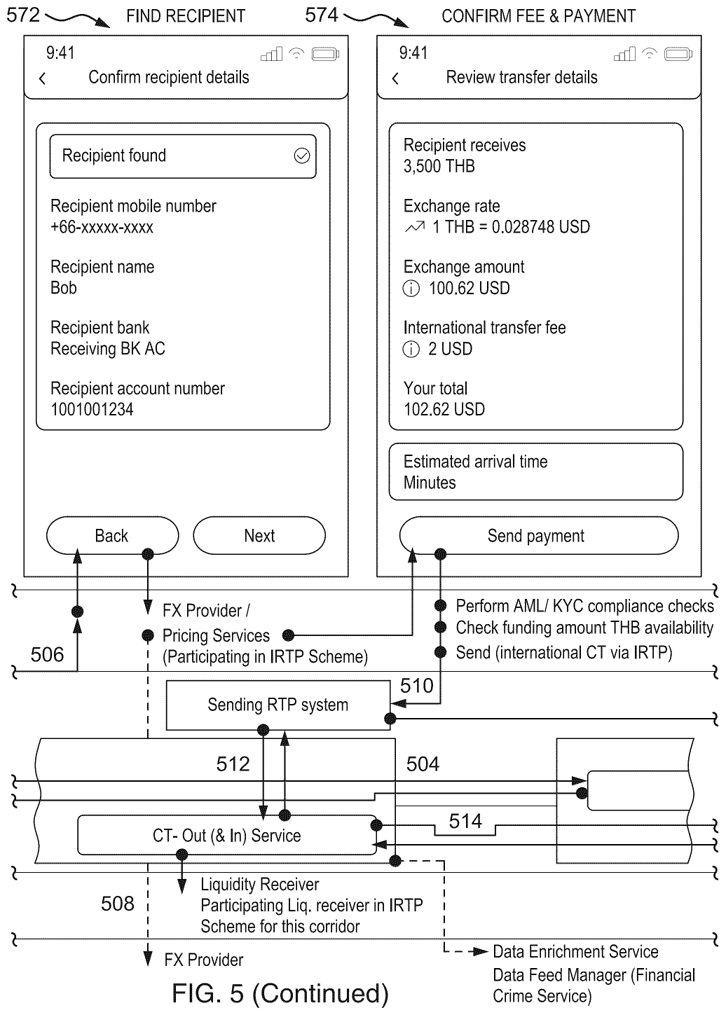

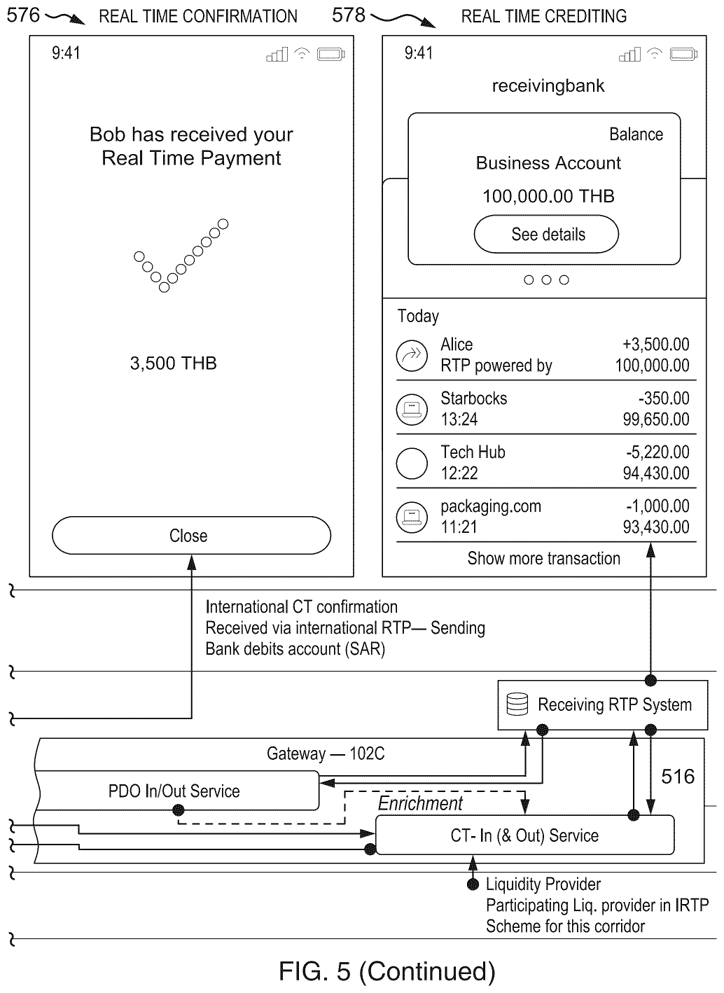

FIG. 5 illustrates another example method 500 for use in facilitating a cross-border, or cross-currency, transaction, consistent with the above system 100 and method 300. The description above should therefore be understood to also apply to the method 500. While the method 500 is generally consistent with the above description of the operation of the system 100, as including the computing device 200, it should be appreciated that the methods herein are not limited to the system 100, or computing device 200. And, likewise, the systems and computing devices described herein are not limited to the example method 500.

At the outset in the method 500, in this specific example embodiment, Alice wants to send a real time payment to Bob, based on Bob's phone number, which is represented by +66-XXXXX-XXXX (i.e., having country code for Thailand, which may be Region C). Alice is located in the United States, which may be Region A, and the institution 104A is also located in the United States. In connection therewith, Alice may access a mobile application on a mobile device (e.g., a mobile phone, tablet, etc.) and indicate a desire to transfer the funds to Bob. In response, the mobile device displays an interface 570 to Alice, which solicits an amount of a transfer and a proxy of the recipient, Bob. Alice then enters, via the interface 570, the phone number for Bob, represented by +66-XXXXX-XXXX, and the amount of the transfer in the destination currency, for example, 3,500 THB in this example, and affirms the entries (e.g., via a Next button, etc.). That said, it should again be appreciated that Alice may proceed in a similar manner using an application or web browser on a desktop computing device, etc.

In response, at 502, the mobile device submits a transfer instruction to the institution 104A in Region A, which is the institution that issued Alice's account from which the funds are to be transferred. In connection therewith (at 502), the institution 104A submits the transfer request to the RTP provider 106A in Region A, in this example, and the RTP provider 106A then submits (also as part of 502) the transfer request to the gateway 102A.

Upon receipt of the transfer request, the gateway 102A (e.g., via the PDO in/out service 110A, etc.) facilitates a pre-credit transfer set up between Region A (e.g., the US, etc.) and Region C (e.g., Thailand, etc.), and retrieves Bob's account information using his phone number. In particular, the gateway 102A submits the proxy for Bob to the gateway 102C, which is located in Region C or Thailand in this example. The gateway 102C resolves the proxy, which in this example, is the phone number for Bob, into account data, which may include, without limitation, an account number indicative of the account of Bob, as issued by the institution 104C. When the proxy is resolved, the account data is passed from the PDO in/out service 110C to the PDO in/out service 110A. The gateway 102A then displays, at 506, the retrieved information to Alice at her communication device, via an interface 572 (e.g., by passing the information through the RPT provider 106A and the institution 104A, and then to Alice's communication device; etc.).

When Alice accepts the information provided for Bob, via the interface 572, the gateway 102A requests, at 508, an exchange quote from USD to THB, from the host 108 (as a FX provider). The host 108 responds with the exchange quote, which is displayed to Alice at her communication device, via an interface 574. In this example embodiment, upon approval of the exchange quote by Alice, via the interface 574, Alice's institution 104A performs, at 510, one or more compliance checks regarding the transfer and confirms the funding amount is available. When complete, the gateway 102A picks up the transfer request, at 512, and routes the transfer request (e.g., via the CT out 114A, etc.), at 514, to the gateway 102C.

In turn, the gateway 102C, and specifically, the CT in service 112C, transforms the message to a format consistent with the host 108 in Region C (which may include enriching the data with the information previously stored against a cross border transaction identifier) and sends, at 516, the transfer to the RTP provider 106C in Region C. The RTP provider 106C checks an account associated with the host 108 in Region C and sends the transfer, in local currency (e.g., THB, etc.), to the institution 104C. The institution 104C accepts the transfer and the RPT provider 106C then settles the transfer between the host 108 and the institution 106C. The RTP provider 106C notifies the gateway 102C of the transfer, and the gateway 102C notifies the host 108 of the transfer, at 358. The gateway 102C also notifies the gateway 102A of the transfer. In doing so, interface 576 may be displayed to Alice confirming the real time transfer is complete. And, interface 578 may be displayed to Bob confirming credit of the funds to his account.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims and/or otherwise recited herein, including: (a) receiving, from an institution, a transfer request for a real-time transfer, via a real-time payment (RPT) provider, from a sender user to a recipient user, the transfer request including an amount to be transferred and a proxy unique to the recipient user, the institution located in a first region, which is associated with a first currency, and the recipient user located in a second region, which is associated with a second currency; (b) resolving the proxy into account data for an account of the recipient user; (c) requesting a quote associated with conversion of the amount in the first currency to the second currency; (d) directing the RTP provider to transfer funds, as defined by the quote, from the institution associated with the sender user to a liquidity receiver in the first region; (c) submitting the transfer request to a second gateway computing device in the second region; (f) receiving a confirmation of the real-time transfer in the second region; and/or (g) notifying the RTP provider of the real time transfer to the recipient user in the second region.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for cross-border network messaging, the method comprising:
receiving, by a gateway computing device of a payment system, from an institution, a transfer request for a real-time transfer, via a real-time payment (RPT) provider, from a sender user to a recipient user, the transfer request including an amount to be transferred and a proxy unique to the recipient user, the institution located in a first region, which is associated with a first currency, and the recipient user located in a second region, which is associated with a second currency;
resolving, by the gateway computing device, the proxy into account data for an account of the recipient user;
requesting, by the gateway computing device, a quote associated with conversion of the amount in the first currency to the second currency;
directing the RTP provider to transfer funds, as defined by the quote, from the institution associated with the sender user to a liquidity receiver in the first region;
submitting, by the gateway computing device, the transfer request to a second gateway computing device in the second region;
receiving, from the second gateway computing device, a confirmation of the real-time transfer in the second region; and
notifying, by the gateway computing device, the RTP provider of the real time transfer to the recipient user in the second region.

2. The computer-implemented method of claim 1, further comprising, after resolving the proxy into the account data for the account of the recipient user, verifying, by the gateway computing device, a reachability of an institution holding the account of the recipient user and a standing of the account to receive the transfer.

3. The computer-implemented method of claim 1, wherein the quote includes a conversion rate between the first currency and the second currency; and
wherein the proxy including a phone number for the recipient user.

4. The computer-implemented method of claim 1, further comprising:
receiving, by the gateway computing device, from the institution, a second transfer request for a second real-time transfer, via the RPT provider, from a second sender user to a second recipient user, the second transfer request including a second amount to be transferred and a second proxy unique to the second recipient user, the second recipient user located in a third region, which is associated with a third currency;
resolving, by the gateway computing device, the second proxy into second account data for an account of the second recipient user;
requesting, by the gateway computing device, a second quote associated with conversion of the second amount in the first currency to the third currency;
directing the RTP provider to transfer funds, as defined by the second quote, from the second institution associated with the second sender user to the liquidity receiver in the first region;
submitting, by the gateway computing device, the transfer request to a third gateway computing device in the third region;
receiving, from the third gateway computing device, a second confirmation of the second real-time transfer in the third region; and
notifying, by the gateway computing device, the RTP provider of a transfer to the recipient user in the third region.

5. The computer-implemented method of claim 1, wherein the gateway computing device includes a payment data (PD) service and a credit transfer (CT) out service; and
wherein resolving the proxy includes resolving, by the PD service, the proxy; and
wherein submitting the transfer request includes submitting, by the CT out service, the transfer request to a CT in service of the second gateway computing device.

6. The computer-implemented method of claim 1, wherein requesting the quote associated with conversion includes requesting the quote for the conversion from multiple different currency conversion providers; and
further comprising soliciting a selection from the sender user of one of the multiple quotes received rom the multiple different currency conversion providers.

7. The computer-implemented method of claim 6, wherein at least one of the multiple currency conversion providers includes the liquidity receiver.

8. The computer-implemented method of claim 1, wherein each of the different regions is a different country.

9. A non-transitory computer-readable storage medium including executable instructions, which when executed by at least one processor, cause the at least one processor to:
receive, from an institution, a transfer request for a real-time transfer, via a real-time payment (RPT) provider, from a sender user to a recipient user, the transfer request including an amount to be transferred and a proxy unique to the recipient user, the institution located in a first region, which is associated with a first currency, and the recipient user located in a second region, which is associated with a second currency;
resolve the proxy into account data for an account of the recipient user;
request a quote associated with conversion of the amount in the first currency to the second currency;
direct the RTP provider to transfer funds, as defined by the quote, from the institution associated with the sender user to a liquidity receiver in the first region;
submit the transfer request to a second gateway computing device in the second region;
receive, from the second gateway computing device, a confirmation of the real-time transfer in the second region; and
notify the RTP provider of the real time transfer to the recipient user in the second region.

10. The non-transitory computer-readable storage medium of claim 9, wherein the executable instructions, when executed by the at least one processor, cause the at least one processor to:
after resolving the proxy into the account data for the account of the recipient user, verify a reachability of an institution holding the account of the recipient user and a standing of the account to receive the transfer.

11. The non-transitory computer-readable storage medium of claim 9, wherein the quote includes a conversion rate between the first currency and the second currency; and
wherein the proxy including a phone number for the recipient user.

12. The non-transitory computer-readable storage medium of claim 9, wherein the executable instructions, when executed by the at least one processor, cause the at least one processor to:
receive, from the institution, a second transfer request for a second real-time transfer, via the RPT provider, from a second sender user to a second recipient user, the second transfer request including a second amount to be transferred and a second proxy unique to the second recipient user, the second recipient user located in a third region, which is associated with a third currency;
resolve the second proxy into second account data for an account of the second recipient user;
request a second quote associated with conversion of the second amount in the first currency to the third currency;
direct the RTP provider to transfer funds, as defined by the second quote, from the second institution associated with the second sender user to the liquidity receiver in the first region;
submit the transfer request to a third gateway computing device in the third region;
receive, from the third gateway computing device, a second confirmation of the second real-time transfer in the third region; and
notify the RTP provider of a transfer to the recipient user in the third region.

13. The non-transitory computer-readable storage medium of claim 9, wherein the executable instructions, when executed by the at least one processor, cause the at least one processor, in requesting the quote associated with conversion, to request the quote for the conversion from multiple different currency conversion providers; and
wherein the executable instructions, when executed by the at least one processor, further cause the at least one processor to solicit a selection from the sender user of one of the multiple quotes received rom the multiple different currency conversion providers.

14. The non-transitory computer-readable storage medium of claim 13, wherein at least one of the multiple currency conversion providers includes the liquidity receiver.

15. The non-transitory computer-readable storage media of claim 9, wherein each of the different regions is a different country.

16. The non-transitory computer-readable storage medium of claim 9, wherein the executable instructions, when executed by the at least one processor, cause the at least one processor, in resolving the proxy, to search for the proxy in a local proxy directory in the first region.

17. A system for cross-border network messaging, the system comprising:
a gateway computing device located in a first region, which is configured, by executable instructions, to:
receive, from an institution, a transfer request for a real-time transfer, via a real-time payment (RPT) provider, from a sender user to a recipient user, the transfer request including an amount to be transferred and a proxy unique to the recipient user, the institution located in the first region, which is associated with a first currency, and the recipient user located in a second region, which is associated with a second currency;
resolve the proxy into account data for an account of the recipient user;
request a quote associated with conversion of the amount in the first currency to the second currency;
direct the RTP provider to transfer funds, as defined by the quote, from the institution associated with the sender user to a liquidity receiver in the first region;
submit the transfer request to a second gateway computing device in the second region;
receive, from the second gateway computing device, a confirmation of the real-time transfer in the second region; and
notify the RTP provider of the real time transfer to the recipient user in the second region.

18. The system of claim 17, wherein the gateway computing device is further configured to, after resolving the proxy into the account data for the account of the recipient user, verify a reachability of an institution holding the account of the recipient user and a standing of the account to receive the transfer.

19. The system of claim 17, wherein the quote includes a conversion rate between the first currency and the second currency; and
wherein the proxy including a phone number for the recipient user.

20. The system of claim 17, wherein the gateway computing device is configured, by executable instructions, in resolving the proxy, to:
search for the proxy a local proxy directory located in the first region; and
in response to the proxy not being found in the local proxy directory, submit a proxy resolution request to a second gateway computing device located in the second region.
